(19) United States
(12) Patent Application Publication
(10) Pub. No.: US 2026/0028216 A1
(43) Pub. Date: Jan. 29, 2026

(54) CAP REMOVAL TOOL FOR MEMBRANE VESSEL

(71) Applicant: RELCO LLC, Willmar, MN (US)

(72) Inventors: Chris Gault, Marshfield, WI (US); John Edward Zirbel, Stratford, WI (US)

(21) Appl. No.: 19/179,484

(22) Filed: Apr. 15, 2025

Related U.S. Application Data
(60) Provisional application No. 63/634,432, filed on Apr. 15, 2024.

(51) Int. Cl. B67B 7/14; B25B 27/02

(52) U.S. Cl. CPC B67B 7/14; B25B 27/02

(57) ABSTRACT

A device for removing the cap from a membrane vessel is disclosed, the device comprising: a) ring for pushing against the perimeter of a membrane vessel; b) an anvil sleeve secured to the ring by one or more arms; and c) an anvil configured to move within the anvil sleeve and is configured to: i) to connect to a cap on a membrane vessel, and ii) to connect to a device for generating a pulling force; wherein the device can remove a cap from a membrane vessel by connecting the anvil to the cap on a membrane vessel and applying a pulling force to the anvil while the ring presses against the perimeter of the membrane vessel.

This application claims the benefit of U.S. Provisional Application No. 63/634,432, filed Apr. 15, 2024, the contents of which are herein incorporated by reference.

### FIELD

Embodiments herein relate to a device, system, and method for removing a cap from a membrane vessel.

### SUMMARY

In an embodiment, a device for removing the cap from a membrane vessel, the device is included having a) an element for engaging the perimeter of a membrane vessel surrounding a membrane vessel cap, b) an anvil sleeve secured to the element for engaging the perimeter of the membrane vessel, and c) an anvil configured to move within the anvil sleeve and is configured to: i) to connect to a cap on a membrane vessel, and ii) to connect to a device for generating a pulling force, wherein the device can remove a cap from a membrane vessel by connecting the anvil to the cap on a membrane vessel and applying a pulling force to the anvil while the element for engaging the perimeter of a membrane vessel presses against the perimeter of the membrane vessel.

In an embodiment, the element for engaging the permitter of a membrane vessel includes a ring.

In an embodiment, a ring sleeve is secured to the ring.

In an embodiment, the ring sleeve is secured to the ring by a plurality of tabs.

In an embodiment, the ring sleeve is configured with a recess that corresponds to the outer diameter of the membrane vessel.

In an embodiment, the ring sleeve is selected based upon the membrane vessel diameter.

In an embodiment, the ring sleeve has an inner diameter corresponding closely to the outer diameter of the cap of the membrane vessel.

In an embodiment, the sleeve includes an anvil for hooking to a ferrule on a membrane vessel cap.

In an embodiment, the anvil includes a slot along the interior, the slot being open on one side to receive the ferrule on the membrane vessel cap.

In an embodiment, wherein upon removal of the cap from the membrane vessel, the outer diameter of the cap is retained by the inner diameter of the face ring sleeve such that the ferrule of the cap is prevented from release out of the slot in the interior of the anvil, thereby retaining the cap on the device.

In an embodiment, wherein upon locking the anvil onto the ferrule there is a small gap between the front of the face ring and the end of the membrane vessel.

In an embodiment, the anvil has an outer diameter corresponding to an inner diameter of the anvil sleeve.

In an embodiment, the anvil has a threaded end for securing to the device for providing a pulling force.

In an embodiment, the device for providing a pulling force includes a hydraulic punch tool.

In an embodiment, the device for removing the cap from a membrane vessel is secured to the hydraulic punch tool.

In an embodiment, the device for removing the cap from a membrane vessel is secured to the hydraulic punch tool by a plurality of set screws.

In an embodiment, the front of the anvil sleeve is recessed from the front of the face ring sleeve.

In an embodiment, wherein anvil sleeve is secured to the element for engaging the perimeter of a membrane vessel by a plurality of reinforcement arms.

In an embodiment, further can include a support ring for hanging the device.

In an embodiment, a device for removing the cap from a membrane vessel, the device is included having a) ring for pushing against the perimeter of a membrane vessel, b) an anvil sleeve secured to the ring by one or more arms, and c) an anvil configured to move within the anvil sleeve and is configured to: i) to connect to a cap on a membrane vessel, and ii) to connect to a device for generating a pulling force, wherein the device can remove a cap from a membrane vessel by connecting the anvil to the cap on a membrane vessel and applying a pulling force to the anvil while the ring presses against the perimeter of the membrane vessel.

In an embodiment, a ring sleeve is secured to the ring and directly contacts the vessel.

In an embodiment, the ring sleeve is secured to the ring by a plurality of tabs.

In an embodiment, the ring sleeve is configured with a recess that corresponds to the outer diameter of the membrane vessel.

In an embodiment, the ring sleeve is selected based upon the membrane vessel diameter.

In an embodiment, the ring sleeve has an inner diameter corresponding closely to the outer diameter of the cap of the membrane vessel.

In an embodiment, the anvil includes a fitting for hooking to a ferrule on a membrane vessel cap.

In an embodiment, the fitting includes a slot along an interior of the anvil, the slot being open on one side to receive the ferrule on the membrane vessel cap.

In an embodiment, wherein upon removal of the cap from the membrane vessel, the outer diameter of the cap is retained by the inner diameter of the face ring sleeve such that the ferrule of the cap is prevented from release out of the slot in the interior of the anvil, thereby retaining the cap on the device.

In an embodiment, wherein upon locking the anvil onto the ferrule there is a small gap between the front of the face ring and the end of the membrane vessel.

In an embodiment, the anvil has an outer diameter corresponding to an inner diameter of the anvil sleeve.

In an embodiment, the anvil has a threaded end for securing to the device for providing a pulling force.

In an embodiment, the device for providing a pulling force includes a hydraulic punch tool.

In an embodiment, the device for removing the cap from a membrane vessel is secured to the hydraulic punch tool.

In an embodiment, the front of the anvil sleeve is recessed from the front of the ring sleeve.

In an embodiment, wherein anvil sleeve is secured to the element for engaging the perimeter of a membrane vessel by a plurality of reinforcement arms. In an embodiment, further can include a support ring for hanging the device.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is an exploded perspective view of a cap removal tool assembly in accordance with various embodiments herein.

FIG. 2 is a perspective view of a cap removal tool assembly in accordance with various embodiments herein.

FIG. 3 is an example of a complete system that can be used with the cap removal tool assembly in accordance with various embodiments herein.

FIG. 4 is a partial cross-sectional view of a cap removal tool assembly in accordance with various embodiments herein, showing the cap ferrule fully seated within the cap removal tool anvil.

FIG. 5 is a partial cross-sectional view of a cap removal tool assembly in accordance with various embodiments herein, showing the cap removal tool partially retracted to the point where the ring sleeve is in contact with a membrane vessel perimeter.

FIG. 6 is a partial cross-sectional view of a cap removal tool assembly in accordance with various embodiments herein, showing the cap partially removed from a membrane vessel.

FIG. 7 is a partial cross-sectional view of a cap removal tool assembly in accordance with various embodiments herein, showing the cap removal tool fully retracted and the cap fully removed from a membrane vessel.

FIG. 8 is a front perspective view of an anvil in accordance with various embodiments herein.

FIG. 9 is a back perspective view of an anvil in accordance with various embodiments herein.

FIG. 10 is a top elevational view of a cap removal tool in accordance with various embodiments herein.

FIG. 11 is a side elevational view of a cap removal tool assembly in accordance with various embodiments herein.

FIG. 12 is a side elevational view of an anvil in accordance with various embodiments herein, showing interior features in dashed lines.

FIG. 13 is a top elevational view of an anvil in accordance with various embodiments herein, showing interior features in dashed lines.

FIG. 14 is a front end view of an anvil in accordance with various embodiments herein.

FIG. 15 is a back end view of an anvil in accordance with various embodiments herein.

FIG. 16 is a front elevational view of a face ring in accordance with various embodiments herein.

FIG. 17 is a is a side cross-sectional view of face ring, including Detail A, in accordance with various embodiments herein.

FIG. 18 is a front perspective view of a face ring in accordance with various embodiments herein.

FIG. 19 is a side elevational view of an anvil sleeve in accordance with various embodiments herein, showing interior elements in dashed lines.

FIG. 20 is an end cross sectional view of the anvil sleeve of FIG. 19 taken along Section A-A, in accordance with various embodiments herein.

FIG. 21 is a side cross sectional view of the anvil sleeve of FIG. 19 taken along Section B-B, in accordance with various embodiments herein.

FIG. 22 is a back perspective view of an anvil sleeve in accordance with various embodiments herein.

FIG. 23 is a front perspective view of an anvil sleeve in accordance with various embodiments herein.

FIG. 24 is a back perspective view of a face ring sleeve in accordance with various embodiments herein.

FIG. 25 is a front perspective view of face ring sleeve in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

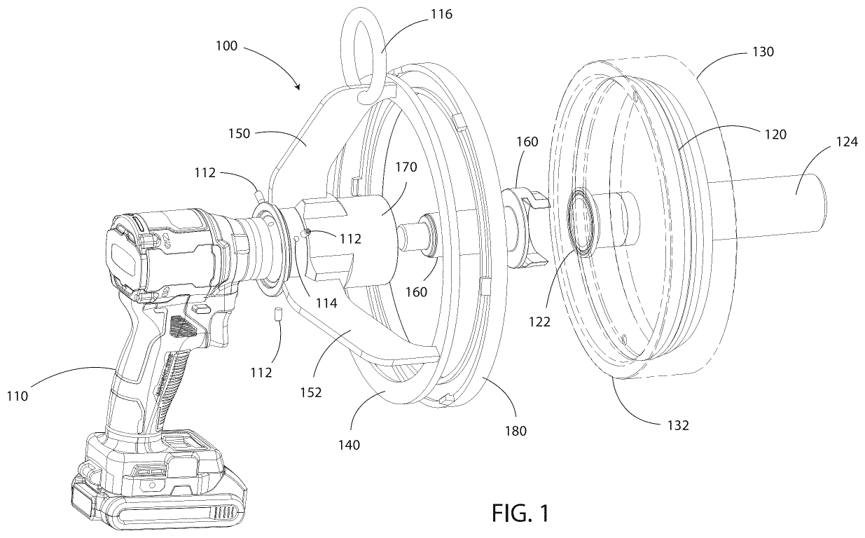

Referring now to FIG. 1, an exploded perspective view of a cap removal tool assembly 100 is shown in accordance with various embodiments herein. In the embodiment depicted, numerous components are depicted, including the cap removal tool assembly 100, along with a portable battery-operated hydraulic punch tool 110 and a membrane vessel 130 (show in dotted lines and in partial view) along with a cap 120. The hydraulic punch tool 110 provides a force to remove the cap 120 from the membrane vessel 130.

In operation, the tool assembly 100 is used to withdraw the cap 120 from the vessel 130 swiftly, consistently, and with minimal effort.

The various components of the tool assembly 100 will now be described, and include a face ring 140, which is secured by reinforcement arms 150, 152 to an anvil sleeve 170. Only two reinforcement arms 150, 152 are shown, but typically there will be three reinforcement arms, with one being out of view in this depiction. One end of each reinforcement arm 150, 152 is secured to the face ring 140, while a second end is secured to an anvil sleeve 170. Generally, the reinforcement arms 150, 152 are welded or otherwise permanently secured to the face ring 140 and the anvil sleeve 170. Thus, the face ring 140, anvil sleeve 170, and the reinforcement arms form a single, rigid structure.

The anvil sleeve 170 has an open interior (not shown) that allows for an anvil 160 to move at least partially into and out of the interior of the anvil sleeve. The anvil 160 is, in turn, secured to the hydraulic punch tool 110 and the hydraulic punch tool 110 provides a force to move the anvil into and out of the anvil sleeve. The overall tool assembly 100 is also secured to the hydraulic punch tool 110 by way of three hex screws 112 into threaded holes 114. It will be appreciated that there are multiple alternative means for securing the tool assembly 100 to the hydraulic punch tool 110. However, in general this should be a rigid connection when installed.

The anvil 160 (shown with two numbers for clarity), described more fully below, fits into anvil sleeve 170 and is attached to the hydraulic punch tool 110 on one end and engages to a ferrule 122 on the cap 120. A face ring sleeve 180 is also shown, which interfaces between the face ring 140 (typically snapping onto the face ring 140) and the vessel collar leading edge 132.

In operation, as described further below, the anvil 160 is mostly extended out from the anvil sleeve 170 and is connected to the ferrule 122 on the cap 120. The other end of the anvil is screwed into the hydraulic punch tool 110. The hydraulic punch tool 110 draws the anvil 160 into the anvil sleeve 170, while the face ring sleeve 180 presses against the perimeter of the vessel collar leading edge 132, thereby applying a force from the anvil 160 to the cap 120 and pulling the cap 120 from the vessel.

Also shown in FIG. 1 is a lifting ring 116 located at the top of the tool assembly 100. The lifting ring 116 allows for securing the tool to a hoist or other device, and is generally located over the center of gravity of the tool assembly 100.

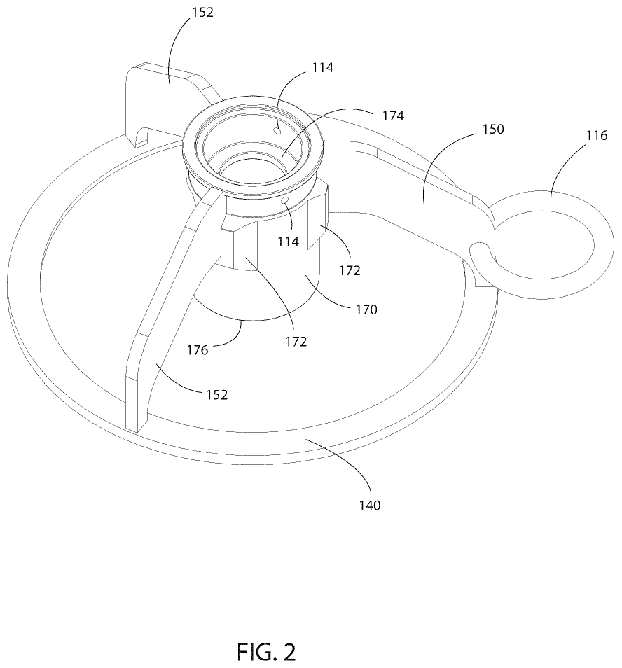

Referring now to FIG. 2, a perspective view of a cap removal tool assembly 100 is shown in accordance with various embodiments herein. The cap removal tool assembly 100 a face ring 140 that is secured to anvil sleeve 170 by way of a first reinforcement arm 150 that is positioned adjacent the lifting ring 116, along with two additional reinforcement arms 152. The reinforcement arms 150, 152 are secured to the anvil sleeve 170 by means of welding or otherwise permanent attachment to the reinforcement regions 172. Also shown are threaded holes 114 for securing the cap removal tool assembly 100 to a hydraulic bunch tool 110. The cap removal tool assembly 100 further shows a surface 174 that generally presses against the end of the hydraulic punch tool 110.

It will be noted that the overall design of the cap removal tool assembly 100 of FIG. 2, and this application in general, can be readily varied. For example, various hydraulic punch tools 110 can potentially be used, and each one may have a different design, requiring different designs for the end of the cap removal tool assembly 100 that engages and is secured to the hydraulic punch tool.

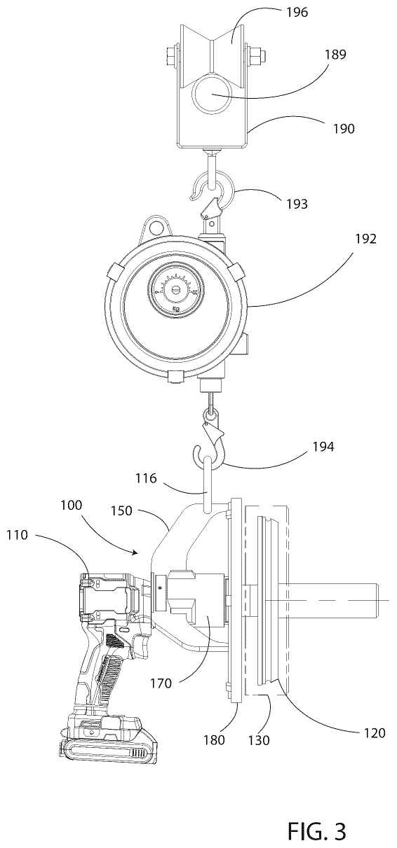

FIG. 3 is an example of a complete system that can be used with the cap removal tool assembly 100. Starting from the top of FIG. 3, vessel skid frame having a pipe 189 (in cross section) incorporated into it can be used to move the assembly horizontally by way of a roller bearing 196 secured to bracket 190.

Below the bracket 190 is an automatic-return hanging retractor 192, typically having a travel range of between 2 and 6 feet (although less and more is possible). The top of the hanging retractor 192 is secured onto the bottom of the bracket 190 by hook 193, while the bottom of the hanging retractor 192 is secured to the lifting ring 116 of the cap removal tool assembly 100. The other components of the removal tool assembly 100 are also shown.

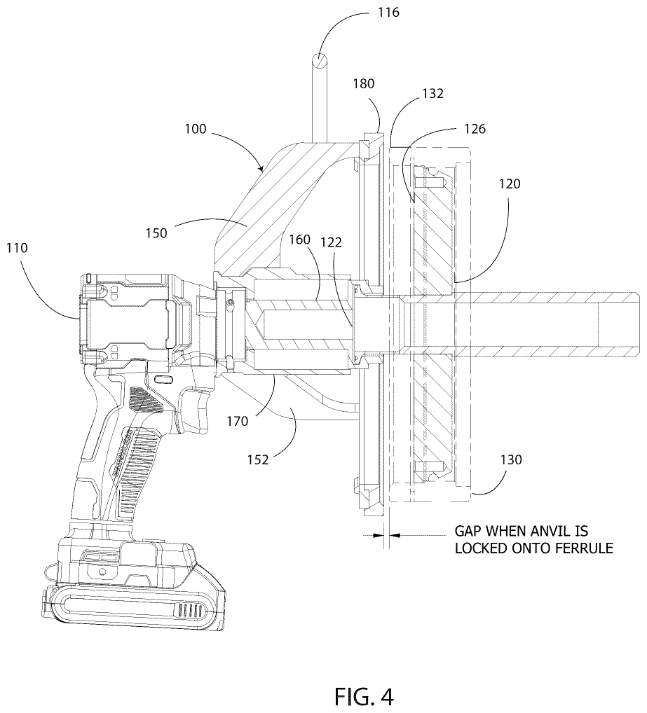

Reference will now be made to FIGS. 4 to 7. FIG. 4 is a partial cross-sectional view of a cap removal tool assembly 100 in accordance with various embodiments herein, showing the ferrule 122 projecting from the cap 120 fully seated within the anvil 160. The membrane vessel 130 is shown in dotted lines, with a leading edge 132. In this illustration the anvil 160 has been secured to a ferrule 122 on the cap 120, and is ready to be removed. In this initial stage there is typically some gap between the leading edge 132 of the membrane vessel 130 and the face ring sleeve 180. For example, this gap can be approximately ⅛ of an inch in some embodiments, but is more or less than ⅛ of an inch in other embodiments. The gap between the leading edge 132 of the membrane vessel 130 and the face ring sleeve 180, allowing for sliding the ferrule 122 into a slot in the side of the anvil 160. Thus, at the stage shown in FIG. 4 the cap removal tool assembly 100 has been latched onto the ferrule 122 projecting from the cap 120 by the anvil 160.

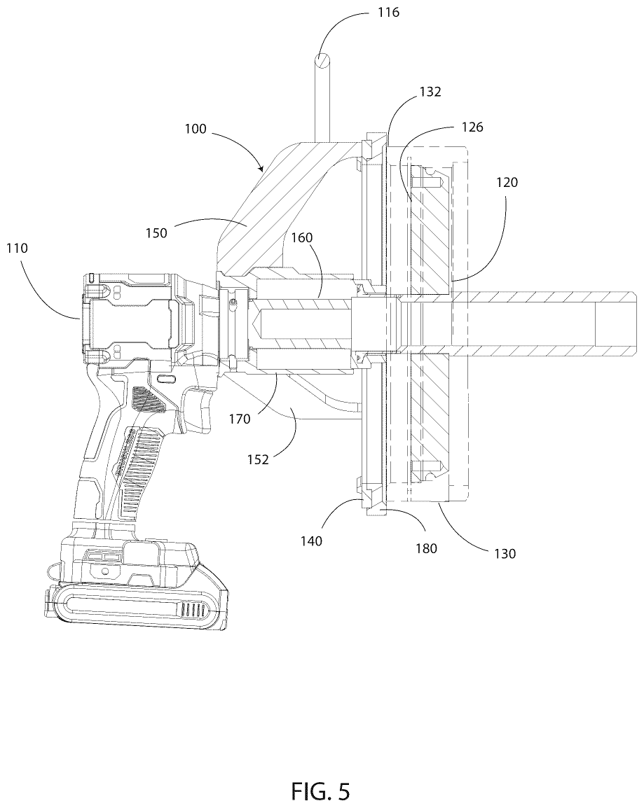

Once the cap removal tool assembly 100 has been latched onto the ferrule 122 projecting from the cap 120 by the anvil 160. FIG. 5 is a partial cross-sectional view of a cap removal tool assembly 100 in accordance with various embodiments herein, showing the cap 120 at initial stage of removal from the membrane vessel 130. The cap 120 and cap removal tool assembly 100 are starting to be drawn together, in particular the gap between the cap 120 and the face ring sleeve 180 is reduced and the membrane vessel 130 is drawn into a corresponding recess in the face ring sleeve 180. In particular, the leading edge 132 of the membrane vessel 130 is drawn into contact with the front (facing the vessel) surface of the face ring sleeve 180. These components are brought together as the anvil 160 is gradually drawn into the anvil sleeve 170 (so movement is right to left in the figure) by the hydraulic punch tool 110.

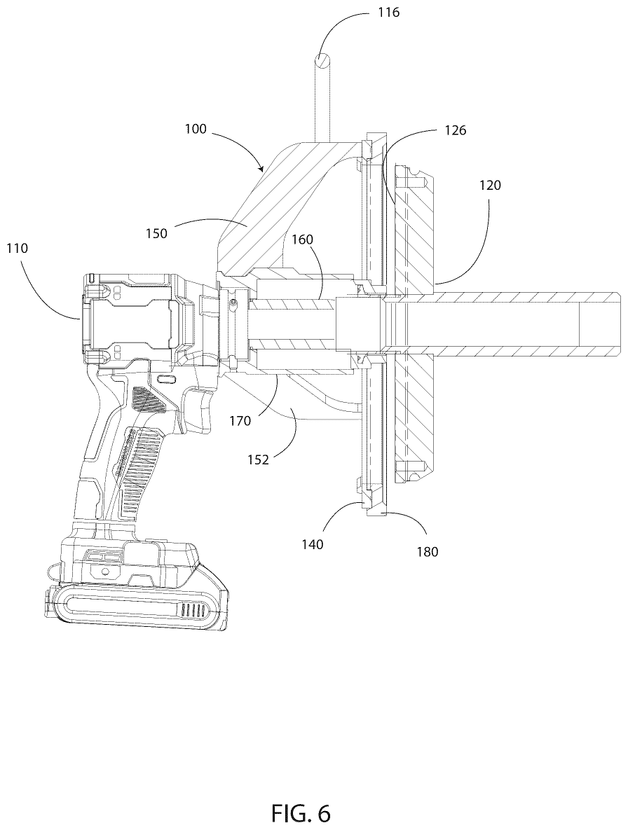

FIG. 6 is a partial cross-sectional view of the cap removal tool assembly 100 showing the cap 120 further pulled toward the face ring sleeve 180. In FIG. 6 the membrane vessel is not shown so as to simplify the illustration, but it will be appreciated that the cap 120 is still within the end of the membrane vessel 130, but is in the process of being removed.

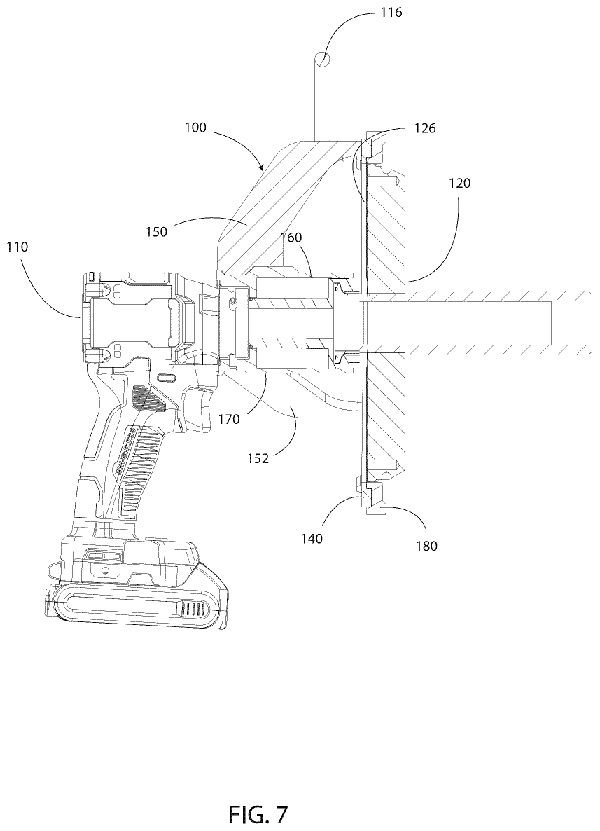

FIG. 7 is a partial cross-sectional view of the cap removal tool assembly 100 showing the cap 120 now fully removed from the membrane vessel, with the anvil 160 retained within the anvil sleeve 170. Indeed, the retention of the ferrule 122 of the cap within the anvil 160 secures the cap 120 in place, and the cap 120 does not readily fall out of the anvil 160 because the anvil 160 is itself fully retracted within the anvil sleeve 170, thereby preventing the removal of the ferrule 122 of the cap 120 until such time as the hydraulic punch tool 110 has been disengaged and it's retraction has been released. At this stage it is possible to move cap removal tool assembly 100, as well as the hydraulic punch tool 110 and the cap 120 away from the membrane vessel 130. A new membrane can be placed within the membrane vessel 130, and then the cap 120 returned to the vessel. Alternatively, the cap 120 can be removed from the cap removal tool assembly 100 by reversing the hydraulic punch tool 110 and removing the ferrule 122 of the cap 120 from the slot in the anvil 160.

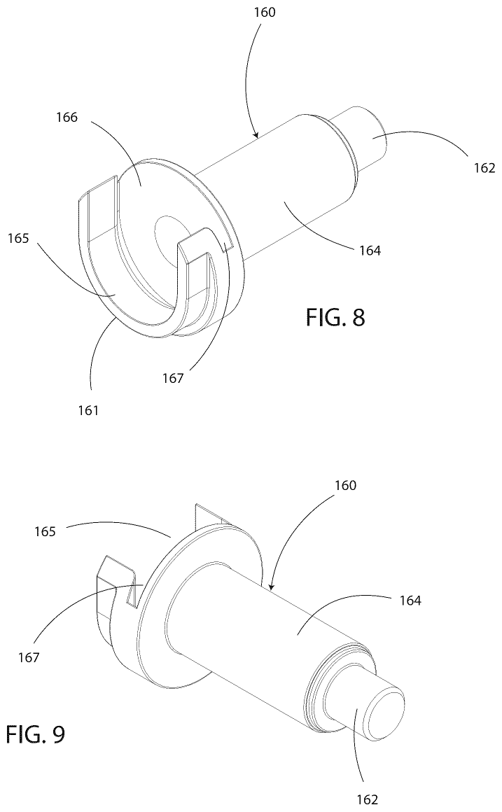

FIG. 8 is a front perspective view of an anvil 160 in accordance with various embodiments herein; and FIG. 9 is a back perspective view of an anvil 160 in accordance with various embodiments herein. Anvil 160 shows a front end 161 configured to secure the ferrule of a cap, a back end 162 that is typically threaded to screw into the hydraulic punch tool 110 (shown elsewhere), and a cylindrical body 164. The front end 161 includes a wall 165 that partially wraps around the ferrule of the cap (not shown), including an open side 166 with a slot 167. The edge of the ferrule can slide through the open side 166 into the slot 167. It is possible to use different types of anvils for different ferrules.

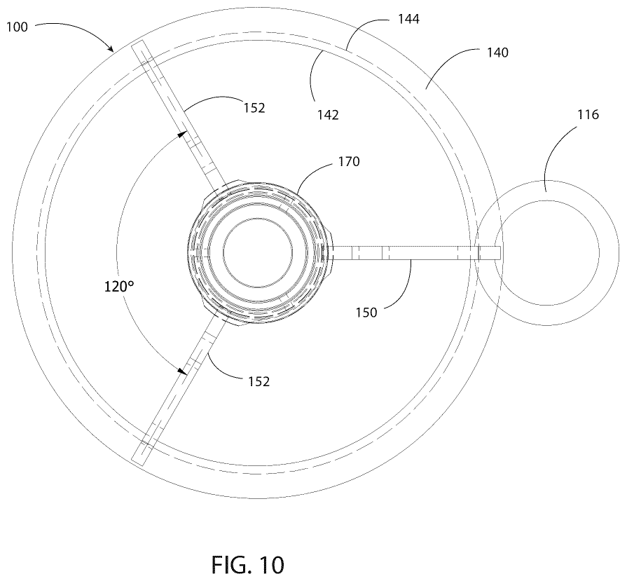

FIG. 10 is a front perspective view of a cap removal tool assembly 100 in accordance with various embodiments herein, showing the face ring 140, with an inner edge 142 and a central edge 144; these edges are designed to receive the face ring sleeve 180. Also shown are the anvil sleeve 170 with reinforcement arms 150 and 152.

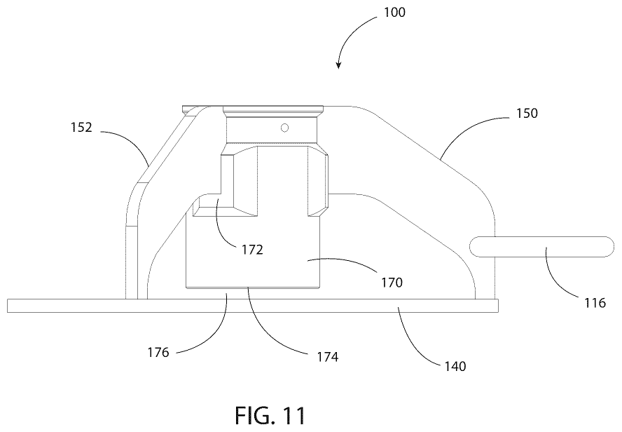

FIG. 11 is a side elevational view of the same cap removal tool assembly 100. Here the reinforcement regions 172 are shown, which help to position and the reinforcement arms 150 and 152, and also strengthen the joint between the reinforcement arms 150, 152 and the anvil sleeve 170. Also visible in FIG. 11 is a gap 176 between the front (lower, here) surface of the anvil sleeve 170 and the face ring 140.

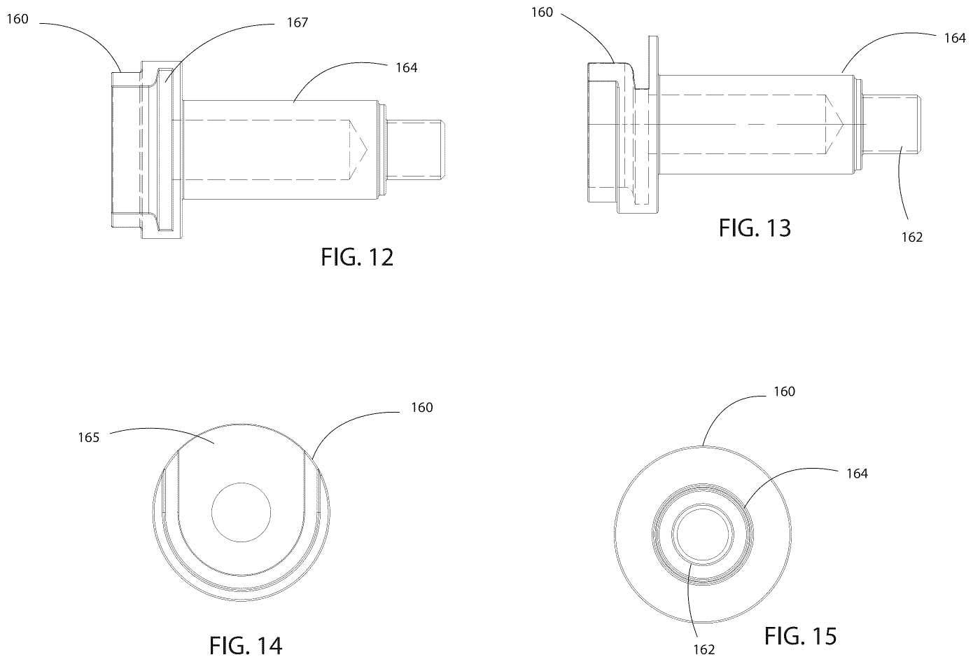

FIGS. 12 to 15 are various additional views of the anvil 160. FIG. 12 is a elevational view of the anvil 160; in accordance with various embodiments herein, showing interior features in dashed lines. FIG. 13 is a side elevational view of the anvil 160, rotated 90 degrees from the depiction in FIG. 12. FIG. 14 is a top view of the anvil 160, FIG. 15 is a back end view of the anvil 160.

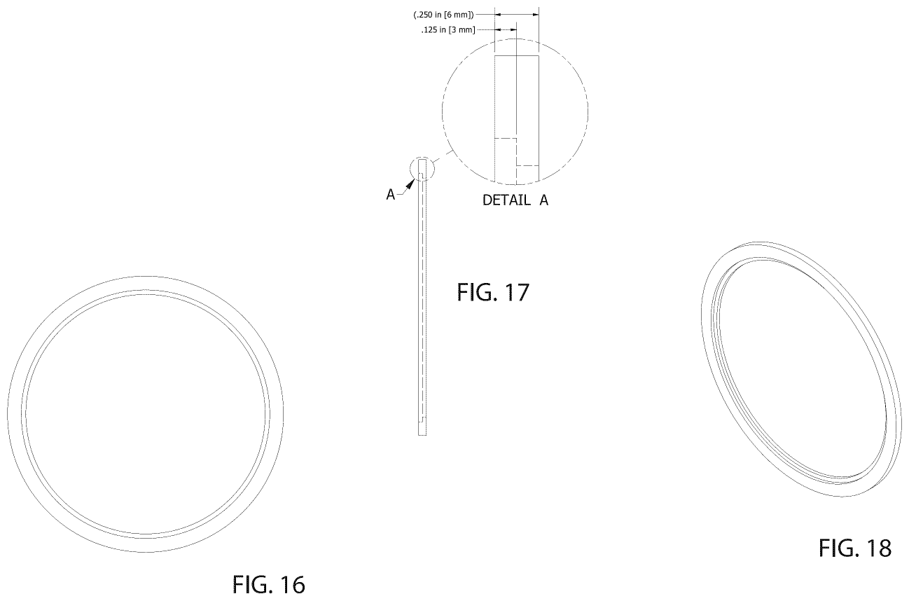

FIG. 16 is a front elevational view of a face ring 140 in accordance with various embodiments herein. FIG. 17 is a is a side view of face ring 140, including Detail A, in accordance with various embodiments herein. FIG. 18 is a front perspective view of a face ring 140 in accordance with various embodiments herein.

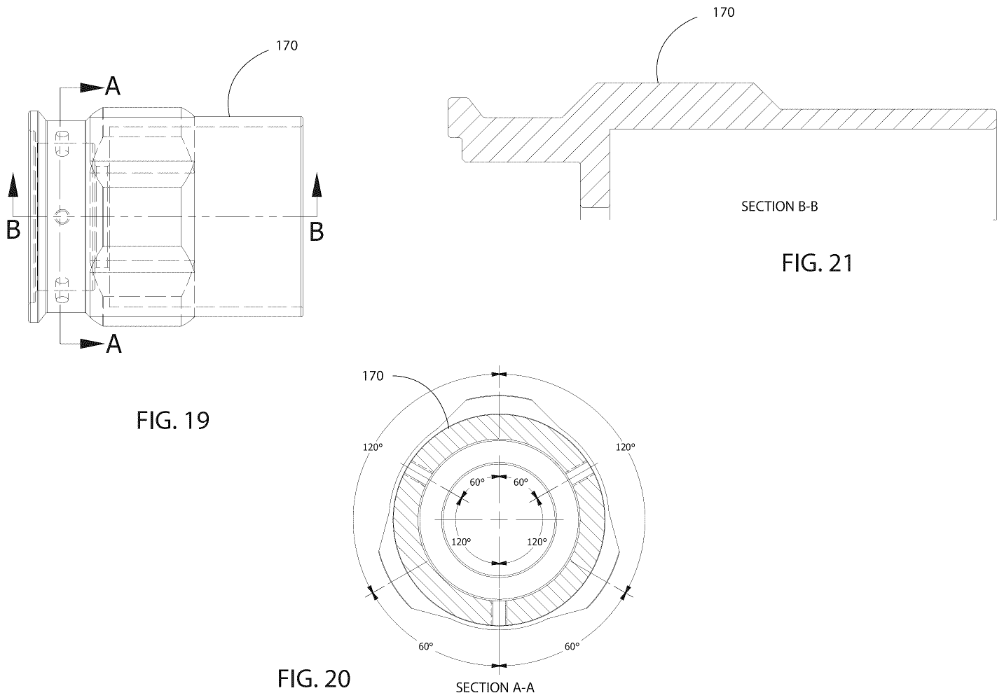

FIGS. 19 to 21 are depictions of an example anvil sleeve 170. FIG. 19 is a side elevational view of the anvil sleeve 170 in accordance with various embodiments herein, showing interior elements in dashed lines. FIG. 20 is an end cross sectional view of the anvil sleeve 170 of FIG. 19 taken along Section A-A, in accordance with various embodiments herein. FIG. 21 is a side cross sectional view of the anvil sleeve 170 of FIG. 19 taken along Section B-B, in accordance with various embodiments herein.

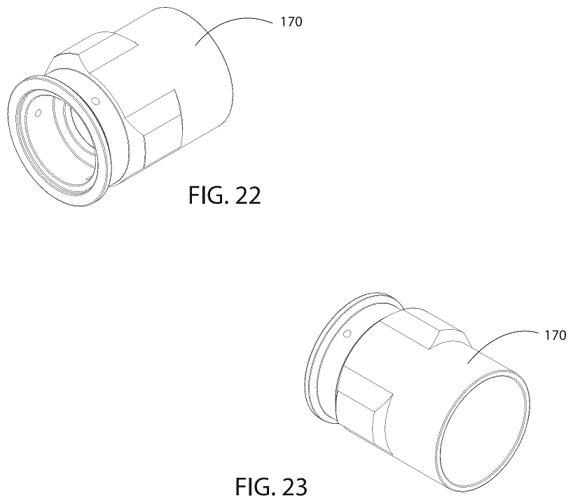

FIGS. 22 and 23 are additional depictions of anvil sleeve 170. FIG. 22 is a back perspective view of anvil sleeve 170 in accordance with various embodiments herein. FIG. 23 is a front perspective view of anvil sleeve 170 in accordance with various embodiments herein.

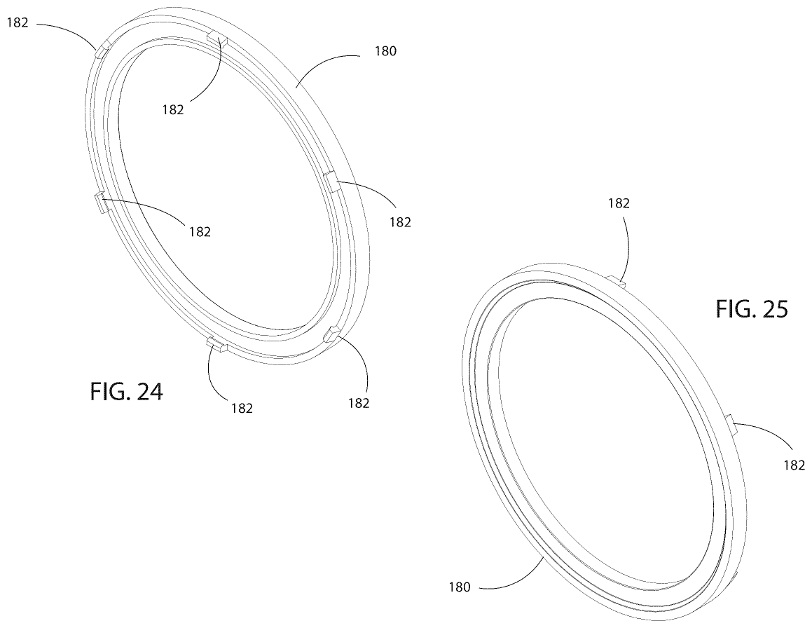

FIG. 24 is a back perspective view of a face ring sleeve 180 in accordance with various embodiments herein. FIG. 25 is a front perspective view of face ring sleeve 180 in accordance with various embodiments herein. The depictions show a series of tabs 182 for securing the face ring sleeve 180 to a face ring 140 (not shown). Face ring sleeves 180 with different interior diameters can be used for removing caps of different outside diameters.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A device for removing the cap from a membrane vessel, the device comprising:
a) an element for engaging the perimeter of a membrane vessel surrounding a membrane vessel cap;
b) an anvil sleeve secured to the element for engaging the perimeter of the membrane surface; and
c) an anvil configured to move within the anvil sleeve and is configured to:
i) to connect to a cap on a membrane vessel, and
ii) to connect to a device for generating a pulling force;
wherein the device can remove a cap from a membrane vessel by connecting the anvil to the cap on a membrane vessel and applying a pulling force to the anvil while the element for engaging the perimeter of a membrane vessel presses against the perimeter of the membrane vessel.

2. The device for removing the cap from a membrane vessel of claim 1, wherein the element for engaging the permitter of a membrane vessel comprises a ring.

3. The device for removing the cap from a membrane vessel of claim 2, wherein a ring sleeve is secured to the ring.

4. The device for removing the cap from a membrane vessel of claim 3, wherein the ring sleeve is secured to the ring by a plurality of tabs.

5. The device for removing the cap from a membrane vessel of claim 1, wherein the ring sleeve is configured with a recess that corresponds to the outer diameter of the membrane vessel.

6. The device for removing the cap from a membrane vessel of claim 1, wherein the ring sleeve is selected based upon the membrane vessel diameter.

7. The device for removing the cap from a membrane vessel of claim 1, wherein the ring sleeve has an inner diameter corresponding closely to the outer diameter of the cap of the membrane vessel.

8. The device for removing the cap from a membrane vessel of claim 1, wherein the anvil comprises a fitting for hooking to a ferrule on a membrane vessel cap.

9. The device for removing the cap from a membrane vessel of claim 8, wherein the fitting comprises a slot along an interior of the anvil, the slot being open on one side to receive the ferrule on the membrane vessel cap.

10. The device for removing the cap from a membrane vessel of claim 8, wherein upon removal of the cap from the membrane vessel, ferrule of the cap is retained by the anvil, which is itself fully retracted into the anvil sleeve such that the ferrule of the cap cannot slide out of the slot in the side of the anvil, thereby retaining the cap on the device.

11. The device for removing the cap from a membrane vessel of claim 1, wherein upon locking the anvil onto the ferrule there is a small gap between the front of the face ring and the end of the membrane vessel.

12. (canceled)

13. The device for removing the cap from a membrane vessel of claim 1, wherein the anvil has a threaded end for securing to the device for providing a pulling force. Preliminary Amendment

14. The device for removing the cap from a membrane vessel of claim 1, wherein the device for providing a pulling force comprises a hydraulic punch tool.

15. (canceled)

16. The device for removing the cap from a membrane vessel of claim 15, wherein the device for removing the cap from a membrane vessel is secured to the hydraulic punch tool by a plurality of set screws.

17. The device for removing the cap from a membrane vessel of claim 1, wherein the front of the anvil sleeve is recessed from the front of the face ring sleeve.

18. The device for removing the cap from a membrane vessel of claim 1, wherein anvil sleeve is secured to the element for engaging the perimeter of a membrane vessel by a plurality of reinforcement arms.

19. (canceled)

20. A device for removing the cap from a membrane vessel, the device comprising:
a) ring for pushing against the perimeter of a membrane vessel;
b) an anvil sleeve secured to the ring by one or more arms; and
c) an anvil configured to move within the anvil sleeve and is configured to:
i) to connect to a cap on a membrane vessel, and
ii) to connect to a device for generating a pulling force;
wherein the device can remove a cap from a membrane vessel by connecting the anvil to the cap on a membrane vessel and applying a pulling force to the anvil while the ring presses against the perimeter of the membrane vessel.

21. The device for removing the cap from a membrane vessel of claim 20, wherein a ring sleeve is secured to the ring and directly contacts the vessel.

22. The device for removing the cap from a membrane vessel of claim 21, wherein the ring sleeve is secured to the ring by a plurality of tabs.

23-28. (canceled)

29. The device for removing the cap from a membrane vessel of claim 20, wherein upon locking the anvil onto the ferrule there is a small gap between the front of the face ring and the end of the membrane vessel.

30-36. (canceled)
